(19) United States
(12) Patent Application Publication
(10) Pub. No.: US 2019/0253351 A1
(43) Pub. Date: Aug. 15, 2019

(54) METHODS AND SYSTEMS FOR HANDLING SCALABLE NETWORK CONNECTIONS

(71) Applicant: Telefonaktiebolaget LM Ericsson (publ), Stockholm (SE)

(72) Inventors: Marcus IHLAR, Älvsjö (SE); Magnus MAGNUSSON, Bromma (SE); Robert SKOG, Hässelby (SE)

(73) Assignee: Telefonaktiebolaget LM Ericsson (publ), Stockholm (SE)

(21) Appl. No.: 16/315,933

(22) PCT Filed: Jul. 8, 2016
(86) PCT No.: PCT/SE2016/050703

§ 371 Date: Jan. 7, 2019

(51) Int. Cl. H04L 12/743; H04L 29/08; H04L 29/06

(52) U.S. Cl. CPC H04L 45/7453; H04L 69/169; H04L 69/162; H04L 67/141

(57) ABSTRACT

There is described a method and system for handling network connections in a server. The method includes: creating a network socket for a network connection in a first memory; monitoring the network connection for activity; and storing state information associated with the network socket in a second memory when there is no activity on the network connection for a predetermined period of time.

### TECHNICAL FIELD

The present invention generally relates to communication networks and, more particularly, handling large quantities of network connections at a server.

### BACKGROUND

Over time the number of products and services provided to users of telecommunication products has grown significantly. Technology advanced and wireless phones of varying capabilities were introduced which had access to various services provided by network operators, e.g., data services. More recently there are numerous devices, e.g., so called “smart” phones and tablets, which can access communication networks in which the operators of the networks, and other parties, provide many different types of services, applications, etc. This has resulted in an increased amount of network traffic which in turn caused an increasing demand for high performing servers.

Existing operating systems consume a certain amount of random access memory (RAM) memory per open transmission control protocol (TCP) socket or TCP connection, e.g., to maintain read and write buffers for the socket, etc. This results in a hard limit on the capacity of a server to handle large amounts of TCP connections. Since a large portion of the TCP connections are open but not transferring data all of the time this adds to the somewhat inefficient consumption of the RAM memory available in a server.

Existing operating systems thus have problems handling large amounts of parallel TCP connections due to having a limited amount RAM memory. It is common for servers to handle large amounts of traffic of different kinds, including long-lived connections with relatively sparse traffic exchanges that coexist with connections used for bulk transfer. Long-lived connections consume system resources throughout their existence and a large number of such long-lived connections have a large impact on the available RAM at the server, even though these connections do not consume much in terms of other network resources, e.g., bandwidth.

Examples of proxy productions systems which are required to handle two million parallel connections per blade are not uncommon to find in use today. This amount of connections per blade server results in high requirements on the RAM memory with deployments of up to 256 GB of RAM. However addressing the problem of RAM consumption due to network socket support simply by continuing to add more RAM to newer servers is an unscalable solution due to cost.

Virtual memory is the combination of physical memory and swap space on disk. Although swapping is an automatic way of allowing higher memory utilization, the kernel itself cannot swap memory. Thus, for the above-described requirements on massively parallel connections the memory consumption of the sockets in the kernel is a limiting factor which cannot be alleviated by employing virtual memory. Additionally, moving to a user space TCP/Internet Protocol (IP) stack will allow swapping of all the memory to disk but the control of when the swapping occurs is not decided by the application itself. Thus even active connections can be swapped to disk incurring a large delay and reducing the throughput making this approach undesirable.

Thus, there is a need to provide methods and devices that overcome the above-described drawbacks of the associated with handling a large quantity of network connections.

### SUMMARY

Embodiments allow for handling large amounts of parallel network connections with a limited amount of RAM by saving a socket to a persistent storage based on certain criteria and then releasing that socket from RAM. The socket can be re-activated when new data arrives on its associated network connection.

According to an embodiment, there is a method for handling network connections in a server. The method includes: creating a network socket for a network connection in a first memory; monitoring the network connection for activity; and storing state information associated with the network socket in a second memory when there is no activity on the network connection for a predetermined period of time.

According to an embodiment, there is a server for handling network connections. The server includes: a first memory in which a network socket for a network connection is created; a processor which monitors the network connection for activity; and a second memory in which state information associated with the network socket in the second memory when there is no activity on the network connection for a predetermined period is stored.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows a sequence of how transmission control protocol (TCP) socket state information can be stored according to an embodiment;

FIG. 2 shows another sequence of how TCP socket state information can be stored according to an embodiment;

FIG. 3 shows another sequence of how TCP socket state information can be stored according to an embodiment;

FIG. 4 illustrates an example of when to read TCP socket state information according to an embodiment;

FIG. 5 show a flowchart of a method for handling network connections in a server according to an embodiment; and

FIG. 6 shows a server according to an embodiment.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As described in the Background, there are problems associated with current methods of handling a large quantity of network connections. Embodiments allow for handling large amounts of parallel network connections with a limited amount of random access memory (RAM) by saving the network socket to a persistent storage based on certain criteria and then releasing that network socket from RAM. The network socket can be re-activated when new data arrives on its associated network connection

A server typically creates a network socket when it receives a data segment with a particular flag set. For example, a transmission control protocol (TCP) server creates a TCP socket when it receives a TCP segment with the SYN flag set. By generically using the term “socket” in the description, it is to be understood that embodiments can be applied to TCP sockets, user datagram protocol (UDP) sockets and other types of network sockets and associated features/items, e.g., segment, server, flag, port, connection, etc.

Prior to discussing various embodiments, some terminology is first introduced. De-multiplexing, as used herein, describes the process of associating an IP datagram with a process and/or network socket listening to a specific network port. Serialization, as used herein, refers to a process of determining that a network socket which is established in RAM should be de-established in RAM and have its state information stored in secondary memory. De-serialization refers to the reverse process, i.e., the case where a socket has its state information stored in secondary memory, which state information is used to re-establish that socket in RAM as part of the de-multiplexing process.

One characteristic which can be monitored to determine if a particular network socket should be serialized is the socket's usage over time. According to an embodiment, each network socket can be associated with an inactivity timer which is reset whenever there is activity on its network connection. When the timer reaches a configured timeout value, a serialization process is initiated where state information associated with the network socket is stored in a socket-cache located in a secondary memory or storage, e.g., a persistent or non-volatile memory. A hash is computed from the connection five tuple in order to create a unique identification for the serialized socket. An example of a five tuple for TCP is “192.160.111.100/40111/71.100.122.70/71/6” for a packet arriving from port 40111 of IP address 192.160.111.100 with the packet arriving at port 71 of IP address 71.100.122.70 and using TCP. Similarly, a five tuple can be created for other protocols, e.g., UDP.

A purely illustrative example of a hash using the above-described five tuple can be mapped out as shown in Equation 1.

hash=(ip_source*Z)XOR ip_destination XOR source_port XOR(dst_port bitshifted 16)XOR proto_number (1)

where Z is an arbitrary prime number, in this case 59. Using the above five tuple of 192.160.111.100/40111/71.100.122.70/71/6 and a Z value of 59, the hash generated is 189580069603, given that the values are used in host byte order. Bitshifting is performed in this example because the IP addresses are 32-bit while the port number is only 16-bit. In this exemplary hash function, using the bitshifting and the arbitrary prime number Z allows a higher likelihood of obtaining a unique hash.

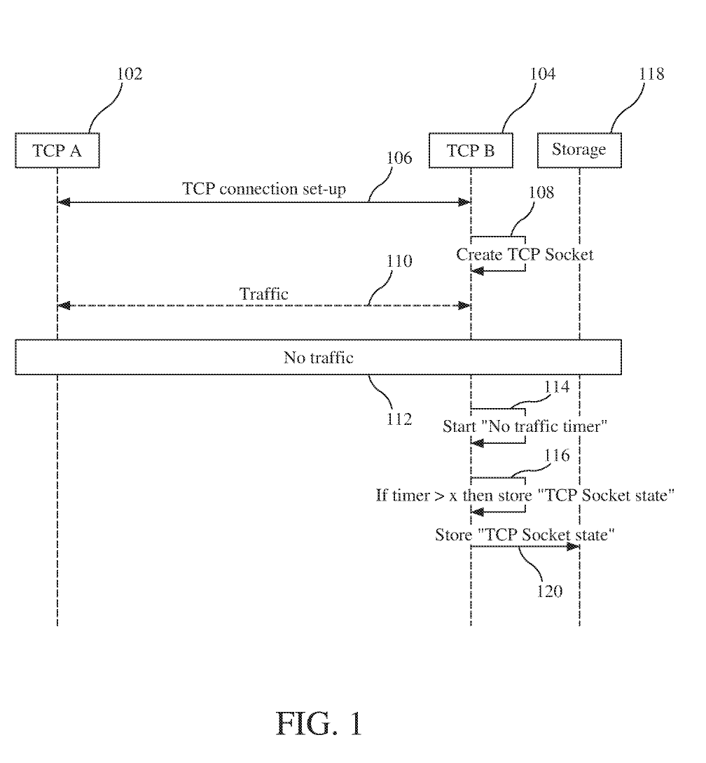

The socket state information stored in the secondary memory is named with the given hash value. State information associated with the network socket and the network connection includes, but is not limited to, a source port, a destination port, connection established information, congestion window, Slow-Start Threshold (SSThresh) value, RTO state, a memory window size, negotiated options such as Selected Acknowledgement (SACK), maximum segment size (MSS), Window scaling, etc., as well as last sent/acked sequence number/acknowledgement number. The network connection hash is also stored in a lookup table in a primary memory, e.g., RAM memory of a blade server, and the lookup table is available to the IP-routing portion of the network stack. After serialization, all state information associated with the network socket and network connection is freed from the primary memory, thereby returning the RAM used to maintain that socket to the pool of free RAM that is available to the server for other purposes. Examples of storing network socket information when not in use according to various embodiments are described below in more detail with respect to FIGS. 1-3. Additionally, while FIGS. 1-3 are shown using TCP, other protocols could also be used.

According to an embodiment, FIG. 1 shows a sequence of how TCP sockets' state information can be stored, when not in use, in another storage media and released from RAM. Initially, a TCP connection is set-up between TCP server A (TCP A) 102 and TCP server B (TCP B) 104 as shown in step 106. A TCP socket is then setup by TCP B 104 as shown in step 108. Additionally in step 108, a hash is created for this TCP socket and saved in a lookup table of TCP B 104's primary memory. Traffic occurs between TCP A 102 and TCP B 104 using this TCP socket as shown in step 110. At a future point in time traffic between TCP A 102 and TCP B 104 ceases on this TCP socket as shown in step 112. At that time a so-called “no traffic timer” is activated at TCP B 104 to track the amount of time that there is no traffic between TCP A 102 and TCP B 104 on this TCP socket as shown in step 114. In step 116, when the timer reaches a value greater than a predetermined amount of time “x” then the TCP socket state information is saved. This socket state information is transmitted from a primary memory, e.g., RAM memory, of TCP B 104 to another, different memory storage 118 as shown in step 120. The storage 118 can be a non-volatile form of memory and can be located within TCP B 104 or separately from TCP B 104. Additionally, after the TCP socket state information is saved in step 120, the TCP socket is de-activated in TCP B 104 which frees up a portion of TCP B 104's primary memory. Those skilled in the art will appreciate that although only a single socket is discussed with respect to FIG. 1 that the same process can be performed for any number of sockets which are established by a server.

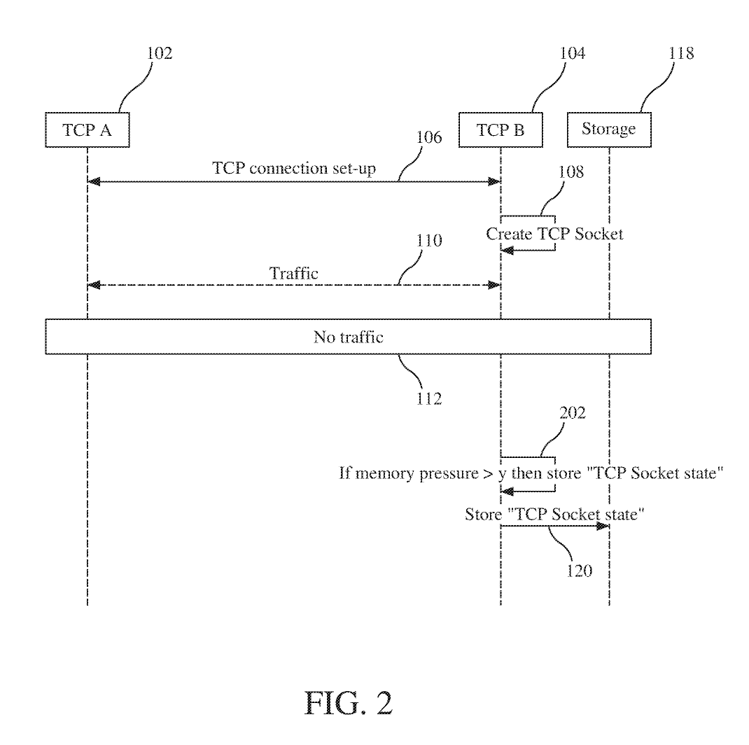

According to an embodiment, FIG. 2 shows another sequence of how TCP sockets' state information can be stored, when not in use, in another storage media. Initially, a TCP connection is set-up between TCP A 102 and TCP B 104 as shown in step 106. A TCP socket is then setup by TCP B 104 as shown in step 108. Additionally in step 108 a hash is created associated for this TCP socket and saved in a lookup table of TCP B 104's primary memory in, for example, a lookup table. Traffic occurs between TCP A 102 and TCP B 104 on this TCP socket as shown in step 110. At a future point in time traffic between TCP A 102 and TCP B 104 ceases on this TCP socket as shown in step 110. In step 202, when the memory pressure, i.e., RAM being used, reaches a value greater than a predetermined amount or percentage of memory “y” then the TCP socket state information is saved. Thus this embodiment introduces another criterion which can be used to trigger socket serialization, memory pressure, as an alternative to or in addition to usage time. This socket state information is transmitted from a primary memory, e.g., RAM memory, of TCP B 104 to another, different memory “storage” 118 as shown in step 120. The storage 118 can be a non-volatile form of memory and can be located within TCP B 104 or separately from TCP B 104. Additionally, after the TCP socket state information is saved in step 120, the TCP socket is de-activated in TCP B 104 which frees up a portion of TCP B 104's primary memory.

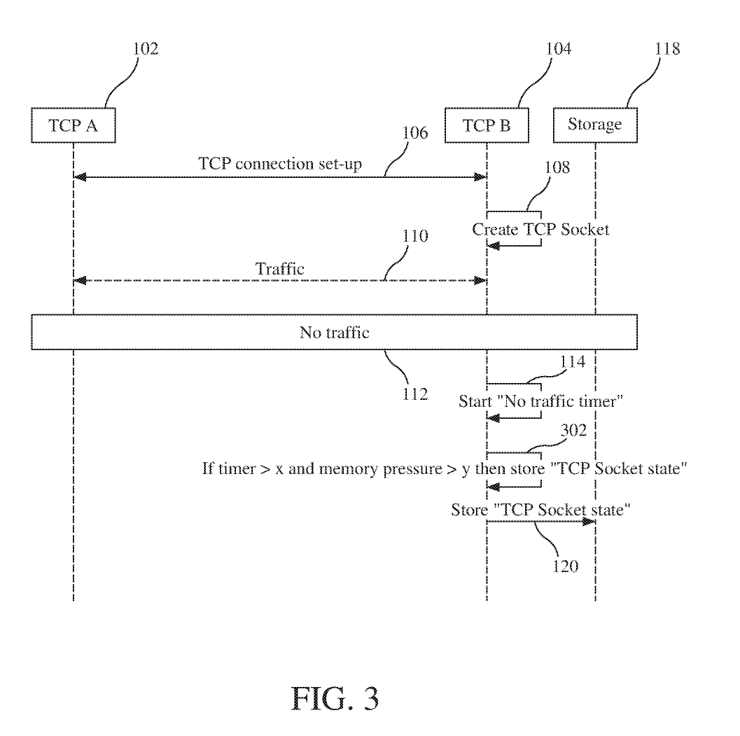

According to an embodiment, FIG. 3 shows another sequence of how TCP sockets' state information can be stored, when not in use, in another storage media. Initially, a TCP connection is set-up between TCP A 102 and TCP B 104 as shown in step 106. A TCP socket is then setup by TCP B 104 as shown in step 108. Additionally in step 108 a hash is created associated for this TCP socket and saved in a lookup table of TCP B 104's primary memory in, for example, a lookup table. Traffic occurs between TCP A 102 and TCP B 104 on this TCP socket as shown in step 110. At a future point in time traffic between TCP A 102 and TCP B 104 ceases on this TCP socket as shown in step 110. At that time a so-called “no traffic timer” is activated at TCP B 104 to track the amount of time that there is no traffic between TCP A 102 and TCP B 104 on this TCP socket as shown in step 114. In step 302, when the timer reaches a value greater than a predetermined amount of time “x” and when the memory pressure reaches a value greater than a predetermined amount or percentage of memory “y” then the TCP socket state information is saved. This TCP socket state information is transmitted from a primary memory, e.g., RAM memory, of TCP B 104 to another, different memory “storage” 118 as shown in step 120. The storage 118 can be a non-volatile form of memory and can be located within TCP B 104 or separately from TCP B 104. Additionally, after the TCP socket state information is saved in step 120, the TCP socket is de-activated in TCP B 104 which frees up a portion of TCP B 104's primary memory.

In FIGS. 1 and 3 the inactivity timer is used for tracking an amount of time with no traffic being transmitted between TCP A 102 and TCP B 104 using a particular socket. The amount of time x is typically a predetermined amount. However, that predetermined amount can be different for different types of traffic as well as being influenced by other items such as configuration, traffic patterns and memory pressure. For example, if the traffic is video, then x could be measured in seconds, e.g., two seconds. If the traffic is a simpler form of data, e.g., text, then x could be measured in milliseconds (ms), e.g., two ms.

According to an embodiment, as described above, another trigger for storing network socket state information is memory pressure. Memory pressure can be described as an amount of free space remaining in a memory. A threshold y can be determined either as a percentage, e.g., ten percent or ten percent below Linux limits, or an amount of memory that when reached could be the trigger for storing network socket state information. This trigger can be used in conjunction with a network socket inactivity timer or by itself, as shown in the previous embodiments. Additionally, when serialization is triggered due to a detection by the server that a memory pressure threshold has been exceeded, a least recently used network socket can be serialized or the inactivity time threshold can be reduced from ‘x’ to another value ‘z’ which is less then ‘x’ to increase the storage of sockets and free up more RAM.

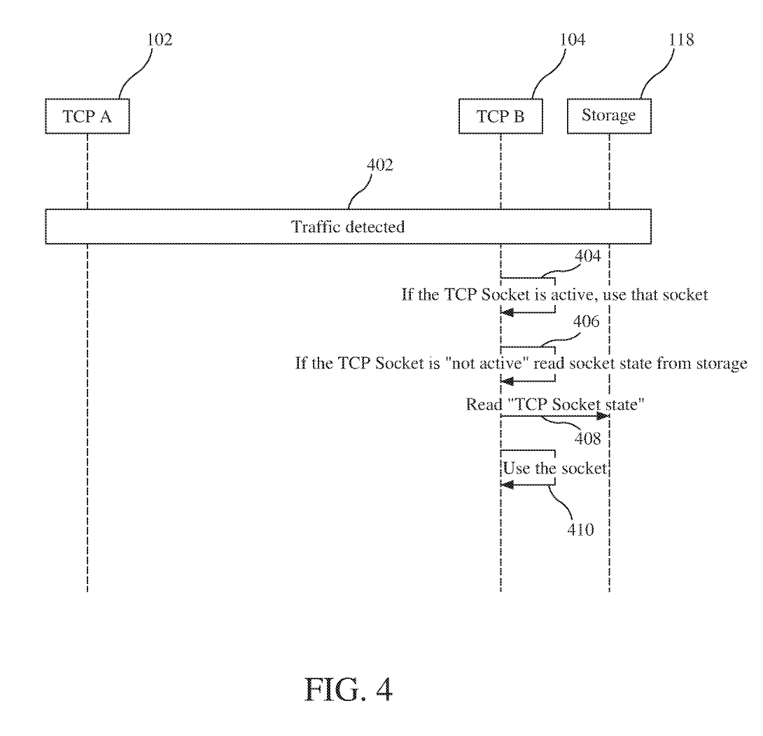

As mentioned previously, serialization, described above with respect to FIGS. 1-3, refers to moving socket state information into secondary memory and releasing that socket from RAM. De-multiplexing refers to handling packets incoming to the server when some sockets have been serialized, which process will now be described with respect to FIG. 4.

According to an embodiment, FIG. 4 shows how to de-multiplex traffic incoming to a server which has (or may have) serialized some of its sockets. Initially, in step 402, traffic is detected between TCP A 102 and TCP B 104. As shown in step 404 if the associated TCP socket associated with the packet received as traffic is active then TCP B 104 uses that active TCP socket. As shown in step 406, if the associated TCP socket associated with the packet received as traffic is not active then TCP B 104 makes the decision to read the TCP socket state information previously stored. In step 408, TCP B 104 reads the TCP socket state information. In step 410, TCP B 104 uses the de-serialized TCP socket.

The de-multiplexing which is generally described above with respect to FIG. 4 can be implemented in different ways. For example, the determination of whether the associated TCP socket associated with an incoming data packet is currently active (step 404) or whether that TCP socket has been serialized (step 406) can be performed in any desired order. If step 406 is performed first, then the process can be implemented as follows. Firstly, for each packet that enters the system and is destined for the blade server compute a hash on the connection five tuple. Then determine if the hash is present in the lookup table of serialized network socket identifiers in the primary memory. If the hash is not present, continue with a standard de-multiplexing procedure, i.e., to find an active socket associated with the five tuple. If the hash is present, initiate de-serialization of the saved network socket state associated with the hash, i.e., associating an IP datagram with the network socket listening to a specific network port. When de-serialization is complete continue with the standard de-multiplexing procedure.

Alternatively, step 404 can be performed first by implementing the flow as follows. Firstly, for each packet that enters the system, perform the standard de-multiplexing procedure to search for an active TCP socket associated with the five tuple. If no network socket is found for the specific connection identifier, compute the hash using the connection five-tuple. Then determine if the hash is present in the lookup table of serialized network socket identifiers in the primary memory. If the hash is not present, continue with a standard de-multiplexing procedure. If the hash is present, initiate de-serialization of the saved network socket state associated with the hash. When de-serialization is complete, forward the packet to the activated network socket.

According to an embodiment, when a socket is de-serialized, the associated hash is removed from the lookup-table and the data stored in the secondary memory is marked as “dirty”. A separate garbage collection process clears the unused data from the secondary memory.

FIGS. 1-4 show embodiments where a single TCP socket is used. A single socket has been shown for simplicity. It is to be understood that the embodiments shown can be scaled up so that many, many more network connections can be created as well as terminated at roughly a same time such that the connections essentially occur in parallel.

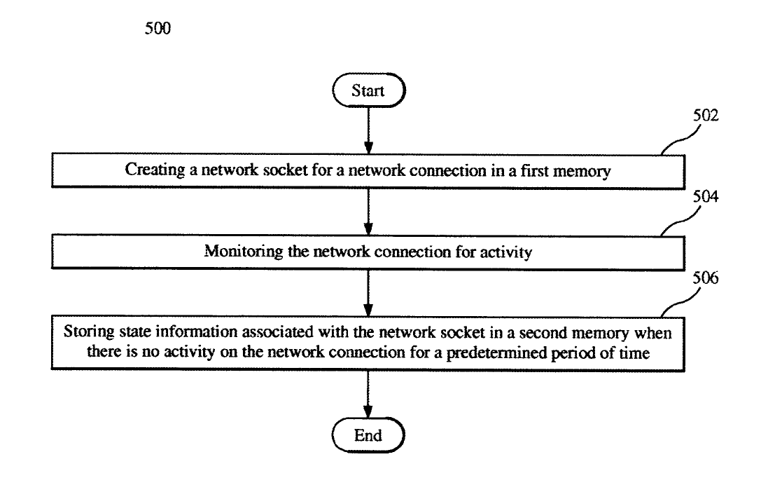

According to an embodiment there is a method for handling network connections as shown in FIG. 5. The method includes: in step 502, creating a network socket for a network connection in a first memory; in step 504, monitoring the network connection for activity; and in step 506, storing state information associated with the network socket in a second memory when there is no activity on the network connection for a predetermined period of time.

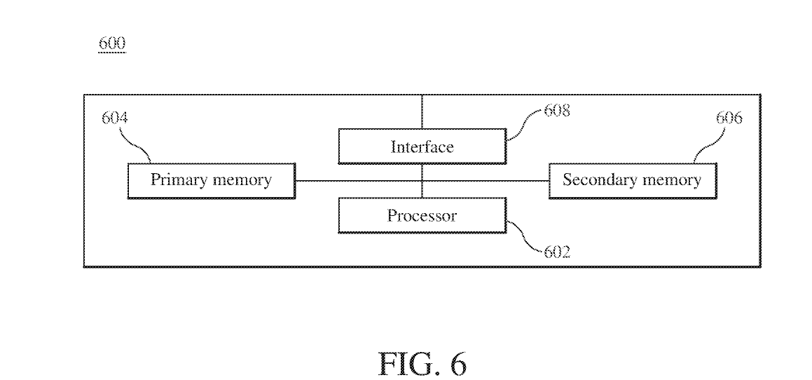

Embodiments described above can be implemented in a device, e.g., the blade server, to improve memory usage via network socket handling. An example of such a blade server is shown in FIG. 6. The blade server 600 includes a processor 602 for executing instructions and performing the functions described herein, e.g., serialization, de-serialization and de-multiplexing. The blade server 600 also includes a primary memory 604, e.g., RAM memory, a secondary memory 606 which is a non-volatile memory, and an interface 608 for communicating with other portions of communication networks. The blade server 600 can act as a TCP proxy server or other device which handles a large number of network connections.

Implementing the various embodiments allows for a better utilization of RAM memory for active network connections, instead of inactive network connections, as well as timely control of when network sockets should be serialized and which sockets to choose for serialization based for example on either a least recently used algorithm or decision criteria on specific IP ranges. For example, the decision criteria could be implemented in any or all of steps 116, 202 and/or 303, from FIGS. 1, 2 and 3 respectively. The decision criteria could only be implemented for one or more IP address ranges which correlate to various subscription levels. Cost savings can be obtained by storing the network socket state information in the secondary, non-volatile memory as compared to only using the primary RAM memory as RAM memory is more expensive than non-volatile memory. This also improves the ratio of the utilization of RAM peer active connection which can be desirable. Additionally, embodiments can benefit highly loaded blade servers where a sudden increase in the amount of network connection attempts would otherwise cause the server to hang.

The disclosed embodiments provide methods and devices for handling large amounts of parallel network connections with a limited amount of RAM. It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the claimed invention. However, one skilled in the art would understand that various embodiments may be practiced without such specific details.

As also will be appreciated by one skilled in the art, the embodiments may take the form of an entirely hardware embodiment or an embodiment combining hardware and software aspects. Further, portions of the embodiments, e.g., the predetermined thresholds or rules to determine the thresholds for x and y, may take the form of a computer program product stored on a computer-readable storage medium having computer-readable instructions embodied in the medium. Any suitable computer-readable medium may be utilized, including hard disks, CD-ROMs, digital versatile disc (DVD), optical storage devices, or magnetic storage devices such as floppy disk or magnetic tape. Other non-limiting examples of computer-readable media include flash-type memories or other known memories.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

1. A method for handling network connections in a server, the method comprising:
creating a network socket for a network connection in a first memory;
monitoring the network connection for activity; and
storing state information associated with the network socket in a second memory when there is no activity on the network connection for a predetermined period of time.

2. The method of claim 1, further comprising:
storing the state information associated with the network socket in the second memory when an inactivity timer reaches a predetermined threshold.

3. The method of claim 1, further comprising:
storing the state information associated with the network socket in the second memory when an inactivity timer reaches a first predetermined threshold and when an amount of free space in the first memory reaches a second predetermined threshold.

4. The method of claim 1, wherein the state information includes a source port, a destination port, connection established information and a memory window size.

5. The method of claim 1, further comprising:
creating a unique identification associated with the network socket by generating a hash value based on a five tuple of the network connection; and
storing the hash value in a lookup table in the first memory.

6. The method of claim 5, further comprising:
removing the state information from the first memory after both storing the state information in the second memory and storing the hash value in the lookup table in the primary memory.

7. The method of claim 1, wherein the first memory is random access memory and the second memory is non-volatile memory.

8. The method of claim 1, further comprising:
retrieving the state information associated with the network socket from the second memory when there is activity on the network connection to re-establish the network socket in the first memory

9. The method of claim 8, further comprising:
generating, for each packet entering the server, a hash based on a five tuple of the packet;
determining whether the hash of the packet matches a hash value stored in the lookup table;
if so, using state information stored in the second memory to re-establish the network socket; and
if not, creating a new network socket to handle the packet.

10. The method of claim 8, further comprising:
performing a de-multiplexing procedure for each packet entering the server;
if a network socket is found for a specific connection identifier associated with a packet determined from the de-multiplexing procedure, then use the network socket to process the packet;
if no network socket is found for the specific connection identifier, then performing the following steps:
generating a hash for a packet based on a five tuple of the packet;
determining whether the hash of the packet matches a hash value stored in the lookup table;
if so, using state information stored in the second memory to re-establish the network socket; and
if not, creating a new network socket to handle the packet.

11. A server for handling network connections, the server comprising:
a first memory in which a network socket for a network connection is created;
a processor which monitors the network connection for activity; and
a second memory in which state information associated with the network socket in the second memory when there is no activity on the network connection for a predetermined period is stored.

12. The server of claim 11, wherein the state information associated with the network socket is stored in the second memory when an inactivity timer reaches a predetermined threshold.

13. The server of claim 11, wherein the state information associated with the network socket is stored in the second memory when an inactivity timer reaches a first predetermined threshold and when an amount of free space in the first memory reaches a second predetermined threshold.

14. The server of claim 11, wherein the state information includes a source port, a destination port, connection established information and a memory window size.

15. The server of claim 11, further comprising:
the processor creates a unique identification associated with the network socket by generating a hash value based on a five tuple of the network connection, wherein the hash value is stored in a lookup table in the first memory.

16. The server of claim 15, wherein the state information is removed from the first memory after both storing the state information in the second memory and storing the hash value in the lookup table in the first memory.

17. The server of claim 11, wherein the first memory is random access memory and the second memory is non-volatile memory.

18. The server of claim 11, wherein the state information associated with the network socket is retrieved from the second memory when there is activity on the network connection to re-establish the network socket in the first memory.

19. The server of claim 18, further comprising:
the processor generates, for each packet entering the server, a hash based on a five tuple of the packet;
the processor determines whether the hash of the packet matches a hash value stored in the lookup table;
if so, using state information stored in the second memory to re-establish the network socket; and
if not, creating a new network socket to handle the packet.

20. The server of claim 18, further comprising:
the processor performs a de-multiplexing procedure for each packet entering the server;
if no network socket is found for a specific connection identifier determined from the de-multiplexing procedure, then the processor performs the following steps:
generating a hash for a packet based on a five tuple of the packet;
determining whether the hash of the packet matches a hash value stored in the lookup table;
if so, using state information stored in the second memory to re-establish the network socket; and
if not, creating a new network socket to handle the packet; and
if a network socket is found for the specific connection identifier then the processor uses the network socket.
